(19) United States
(12) Patent Application Publication
(10) Pub. No.: US 2015/0208591 A1
(43) Pub. Date: Jul. 30, 2015

(54) SYSTEMIC CROP PROTECTION METHOD FOR CONTROLLING MYCOSES, BACTERIOSES AND VIROSES USING INJECTOR TECHNOLOGY AND NEUTRAL ELECTROLYZED MINERAL WATER AS A BIOCIDE

(71) Applicant: Hanspeter Steffen, Alchenstorf (CH)

(72) Inventor: Hanspeter Steffen, Alchenstorf (CH)

(21) Appl. No.: 14/399,711

(22) PCT Filed: May 7, 2013
(86) PCT No.: PCT/CH2013/000079

§ 371 Date: Mar. 30, 2015

(30) Foreign Application Priority Data
May 8, 2012 (CH) 639/12

(51) Int. Cl. A01G 7/06; C25B 9/08; C25B 1/10; C25B 1/00; C25B 1/13; C25B 11/12; C25B 11/04

(52) U.S. Cl. CPC A01G 7/06; C25B 11/12; C25B 9/08; C25B 11/04; C25B 1/00; C25B 1/13; C25B 1/10

(57) ABSTRACT

A systemic crop protection method using, as a systemic biocide, oxidative radicals which are electrolytically produced in mineral salt-containing, plant nutrient-rich water and are filled into devices to carry out injection in the phloem of a plant, bush, or tree. Bacteria, viruses, fungi and yeasts are eliminated by: 1. producing the biocidal oxidative radicals and breaking up the water molecule clusters into two-molecule to three-molecule clusters in an aqueous, mineral salt-containing nutrient solution using electrolysis; 2. filling, under pressure, electrolyzed phyto-physical nutrient solution and biocidal oxidative radicals along with compressed gases, nitrogen, CO2, and/or argon into the injection devices; 3. placing injection cannulae on plants or trees and with the help of a drill, screwing the injection cannulae into the phloem of the plants; 4. grafting on the injection devices; 5. automatically, slowly and constantly administering the injection to the phloem of the plant; 6. repeating as required.

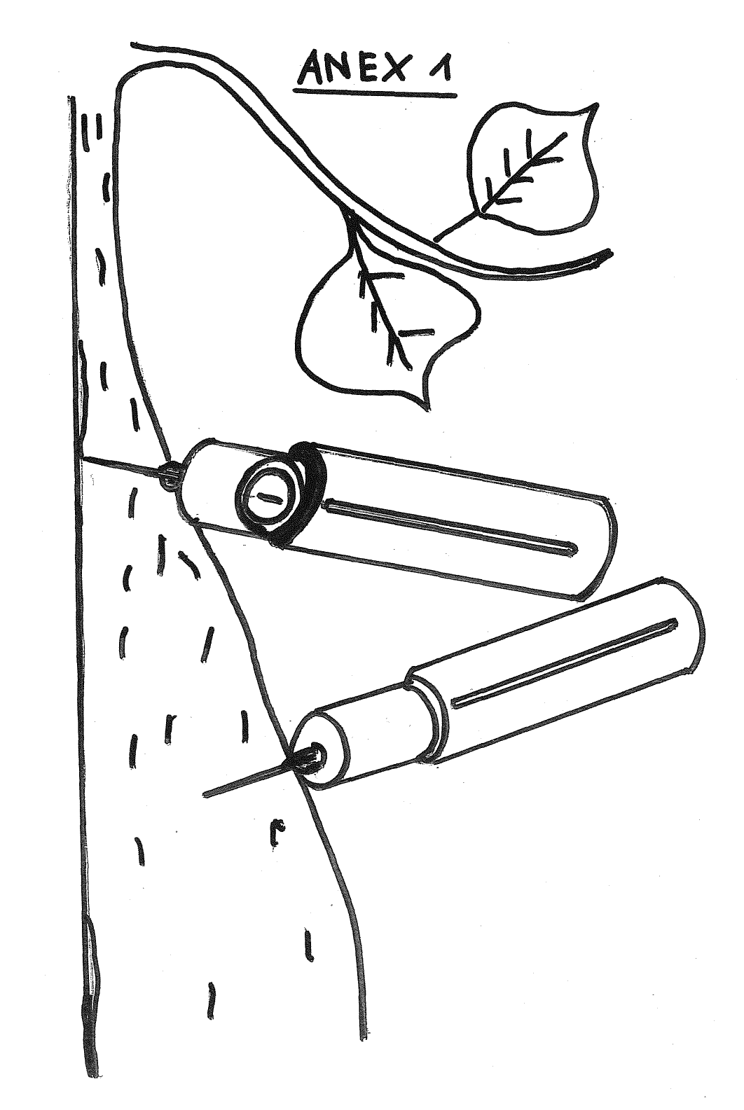

### CROSS-REFERENCE TO RELATED APPLICATIONS

The present application is a 35 U.S.C. §§371 national phase conversion of PCT/CH2013/000079, filed May 7, 2013, which claims priority to Switzerland Application No. CH 639/12, filed May 8, 2012, the contents of both of which are incorporated herein by reference. The PCT International Application was published in the German language.

### TECHNICAL FIELD

The invention relates to a novel crop protection method using, as a systemic biocide, oxidative radicals, which are electrolytically produced in mineral salt-containing water and are filled into a pressurized injection ampoule or into a hand-held injection device, or a specially applied technology integrated into other types of syringes to carry out the injection method in the phloem of a plant, bush or tree, according to the preamble of the independent patent claims.

### STATE OF THE ART

To date, highly toxic chemicals and antibiotics (streptomycin), which form toxic residues in and on useful plants (plants, bushes, trees) and which furthermore cause resistances in phyto-pathogenic parasites and which have no effect and which furthermore cause much harm to the environment and which are also very expensive, were used to fight harmful fungi, bacteria, viruses and yeasts, which appear systemically in plants, bushes and trees.

The use of toxic and antibiotic substances in crop protection is thus highly controversial today and is increasingly ineffective due to the formation of a resistance in the case of pathogens and consumers furthermore prefer cost-efficient plant-based food, which is biologically and ecologically environment-friendly and which is made without chemicals, without toxic ingredients or residues.

The economic damages, which are caused worldwide by the bacterial disease fire blight (Erwinia Amylovora), for example, in pomiculture are enormous. Also the now newly-appearing Huanglongbing (Candidatus Liberibacter spp.), citrus greening disease, which affected the citrus production and the citrus industry severely and which already caused several billions of damages. To date, scientists in the field of agronomy were unable to offer solutions and the use of antibiotics, such as streptomycin in pomiculture, has already resulted in resistances and contaminations of honey in Europe and the USA. Infected trees have to be cut down and destroyed worldwide in the fruit and citrus-growing industry. Thousands of hectares have already been destroyed and the epidemic proportion of the infections, which are caused by bees in pomiculture and by the insect Diaphorina Citri, increase strongly, because the insect infection vectors have already become resistant against most pesticides and because the insect pest control has thus become extremely difficult.

All types of mycoses, bacterioses, viroses and levurioses in plants, bushes and trees can be controlled systemically by means of phloem injections using the novel invention in the systemic application by means of newly developed, special, refillable pressure injectors and with oxidative radicals, which are electrolytically produced in water by adding ion-forming mineral salts, without having to use antibiotic substances, which are toxic and which harm the environment and which form resistances, with a residual effect.

The novel crop protection technology is clean, significantly cheaper, efficient and mainly environmentally friendly and can also be used in ecological and organic farming in a preventative manner. In addition, this new technology allows for an improved systemic effect against pathogens as external spray applications on leaves, etc.

### ILLUSTRATION OF THE INVENTION

It is the task of the invention to specify a novel, efficient and cost-efficient, environmentally friendly and biological systemic method for protecting crop against harmful fungi, bacteria, virus and yeast infestation without residues and resistance-forming chemicals, using, as a systemic biocide, oxidative radicals, which are electrolytically produced in water by adding mineral ion-forming salts, filled into pressurized injection ampoules or into a hand-held injection device, or a special application device integrated into other types of syringes, to carry out the injection method in the phloem of a plant, brush or tree.

### INTRODUCTION

In the laboratory Dr. MERK in Ochsenhausen, Germany, the inventor, Hanspeter STEFFEN, had tests performed relating to the effect of electrolytic water against viruses on the basis of a contractual relationship. In addition to the excellent virucidal effect, a very low cytotoxicity also became apparent thereby, which would suggest that neutral electrolytic water, comprising full diamond electrodes or other electrode types produced with electrical overpotential, has no effect or only a small biocidal effect on living cells.

This fact led to the conclusion that electrolytic water can also be injected into biological systems, without destroying living organic cells.

Laboratory tests confirmed the hypothesis.

Electrolytic water is highly efficient against the bacterium Erwinia Amylovora (fire blight) in pomiculture.

| | | | | | |
|---|---|---|---|---|---|
| Electrolytic water concentration [%] | 98.4 | 19.7 | 3.9 | 0.8 | 0.16 |
| Total radicals [mg/l] | 118 | 23.6 | 4.7 | 0.9 | 0.19 |
| Reduction test 1 | 100 | 0 | 0 | 0 | 0 |
| Reduction test 2 | 100 | 20 | 0 | 0 | 0 |
| Average value | 100 | 10 | 0 | 0 | 0 |
| Standard deviation | 0.0 | 10 | 0 | 0 | 0 |

Electrolytic water is highly efficient against the bacterium for apple scab (Venturia inaequalis) in pomiculture.

TABLE 1
effect of electrolytic water against apple scab. The
p-value specifies the exceeding probability in the two-
sided T-test as compared to the untreated control.

| compound AWK | | infestation | efficiency [%] |
|---|---|---|---|
| average value [%] | standard deviation | | T-test p-value |
| untreated | 5.0 | | 3.4 |
| Electrolysis 100 | 0.4 | 0.4 | 0.00011 92.6 |
| Delan WG | 0.05 | | 95.6 |

AWK = application concentration

After two treatments (2 hours prior to and 1 hour after inoculation), the tested electrolytic water significantly reduced the scab infestation by 92.6% (Table 1). The long-term average in the case of these trials of the fungicide Delan WG was 95.6%.

Electrolytically Produced, Oxidative Water (EOW)

Electrolytically oxidative water (EOW) or chemically active water does not destroy germs, fungi, bacteria, viruses, yeasts, phages and insects chemically, but physically by means of oxidative radicals. Due to its high oxidative reduction potential (ORP), “active water” damages the cell wall membranes of pathogens.

The pathogenic organism is compromised, which leads to an osmotic or hydrogenic overload in the interior of the cell.

The damaged cell membranes allow for an increased water transfer between the cell membranes, which leads to a hydrogenic flooding of the cells, and the cells are filled more quickly than they can get rid of the water.

This fact leads to a bursting of the cells or to the death of the cells, respectively, within a few seconds due to pressure explosion.

Due to the fact that this is a physical destruction principle, it is verifiable that this does not result in resistances in pathogens.

Principle of the Electrolysis

Example of an electrolysis with a zinc iodide solution (any electrode material)

When connecting two small metal plates (electrodes) to a cable and to a device, which generates direct current, e.g. a battery or a rectifier—and when transferring these small plates into a beaker glass comprising an aqueous solution (any ions) and when now applying a voltage, a substance, the ions of which are present in the solution, is formed at both small metal plates.

The voltage source effects an electron deficiency in the electrode, which is connected to the positive pole (anode) and an electron excess in the other electrode, which is connected to the negative pole (cathode). The aqueous solution between the cathode and anode contains electrolytes, which are positively or negatively charged ions. The positively charged cations in an electrolytic cell move to the negatively charged cathode by applying a voltage (attraction of opposite charges). At the cathode, they absorb one or a plurality of electrons and are thus reduced.

The opposite process takes place at the anode. There, the negatively charged anions release electrons, that is, they are oxidized. The number of the electrons used up by the reduction at the cathode corresponds to the electrons absorbed by the anode. In response to the electrolysis of an aqueous saline solution, the same volume of hydrogen gas as of chlorine gas is created.

In response to the electrolysis of water, twice as much hydrogen gas as oxygen gas is created, because the two positively charged protons of a water molecule shift to the cathode and must in each case absorb an electron at that location, so that hydrogen forms, while the double negatively charged oxygen anion must release two electrons at the anode so as to connect to the oxygen molecule.

The voltage, which must at least be applied for the electrolysis, is identified as separation potential. In the case of the electrolysis of water or in the case of aqueous saline solutions, this is also referred to as the decomposition voltage. This voltage (or a higher voltage) must be applied, so that the electrolysis runs at all. For every substance, for every conversion of ions into two-atomic or polyatomic molecules, the decomposition voltage, the separation potential, can be determined by means of the redox potential. Much other important information for the electrolysis, for example for the electrolytic decomposition of metal electrodes in acid or for reducing decomposition voltage by changing pH values, is obtained from the redox potential.

For example, it can be calculated from the redox potential that the formation of oxygen at the anode in response to the electrolysis of water in basic solution (decomposition voltage: 0.410 V) runs under a lower voltage than in acidic solution (decomposition voltage: 1.23 V) or in neutral solution (decomposition voltage: 0.815 V). In contrast, hydrogen is formed more easily at the cathode under acidic conditions than under neutral or basic conditions).

In the event that a plurality of cations, which can be reduced, are present in an electrolyte solution, those cations, which have a more positive (less negative) potential in the redox series (voltage series), which are thus as close as possible to the 0 potential of the proton hydrogen electrode voltage, are initially reduced at the cathode according to the redox series. Normally, hydrogen and not sodium is formed at the cathode in response to the electrolysis of an aqueous saline solution. When a plurality of anion types, which can be oxidized, is present, those anion types are preferred initially, which are as close as possible to the zero-point of the voltage in the redox series, thus those, which have a weaker positive redox potential. Normally, oxygen and not chlorine is thus created at the anode in response to the electrolysis of aqueous NaCl. After exceeding the decomposition voltage, the intensity of current also increases proportionally with the increase of voltage. According to Faraday, the quantity by weight of an electrolytically formed substance is proportional to the amount of current, which flowed (intensity of current multiplied by the time). An amount of current of 96485 C (As)=1 Faraday is required for the formation of 1 g of hydrogen (approx. 11.2 liters, two electrons are required in response to the formation of a hydrogen molecule) from an aqueous solution. In response to an intensity of current of 1 A between the electrodes, the formation of 11.2 liters of hydrogen thus takes 26 hours and 48 minutes.

In addition to the redox potential, the overvoltage (the overpotential) is also significant. Due to kinetic inhibitions at electrodes, a voltage, which is significantly higher than is calculated from the calculation of the redox potentials, is often required. Depending on the material characteristic of the electrodes, the overvoltage effects can also change the redox series, so that other ions than would have been expected according to the redox potential, are oxidized or reduced. Shortly after switching off an electrolysis, a current spike in the other direction can be detected by means of an amperemeter. In this short phase, the reverse process of the electrolysis, the formation of a galvanic cell, starts. Current is hereby not used for the conversion, but current is produced for a short period of time; this principle is used in the case of fuel cells.

If a break-up of individual molecules or bonds is forced by means of an electrolysis, a galvanic element, the voltage of which counteracts the electrolysis, acts at the same time. This voltage is also identified as polarization voltage.

Electrodes

There are only a few anode electrodes, which remain inert during the electrolysis, which thus do not dissolve at all. Platinum, carbon or diamond, respectively, are materials, which do not dissolve at all during an electrolysis. This is identified as “passivity”.

Inhibition phenomena at the anode, which lead to an overvoltage in response to the formation of oxygen, can be observed in the case of diamond and platinum anodes (overvoltage: 3-4 V and 0.44 V). Chlorine instead of oxygen is thereby created in response to the electrolysis of an aqueous saline solution. At zinc, lead (overvoltage: 0.78 V) and in particular pool cathodes (0.80 V), hydrogen protons show a significant overvoltage and the formation of hydrogen only takes place in response to a much higher voltage. The significant overvoltage of hydrogen at the pool cathode, in which the sodium is bonded as amalgam and is thus removed from the equation, is used for technically producing sodium hydroxide. Due to the significant overvoltage at this electrode in response to the formation of hydrogen, the redox series changes and sodium cations instead of hydrogen protons now shift to the pool cathode.

Electrolysis of Water

The electrolysis of water consists of two partial reactions, which run at the two electrodes. The electrodes dip into water, which is made slightly more conductive by adding some sodium chloride, whereby chlorine is then obtained instead of oxygen.

Positively charged hydronium ions (H₃O⁻) shift to the negatively charged electrode (cathode) in the electrical field, where they each absorb an electron. Hydrogen atoms, which combine with a further H-atom, which was created by means of reduction, to form a hydrogen molecule, are created thereby. What remains are water molecules.

2H₃O⁺+2 e⁻→H₂+2H₂O

The separated, gaseous hydrogen rises at the cathode.

The negatively charged hydroxide ions shift to the positively charged electrode (anode).

Each hydroxide ion releases an electron to the positive pole, so that oxygen atoms are created, which combine to form oxygen molecules or to chlorine molecules, respectively, in response to adding NaCl.

The remaining H^{|} ions are neutralized immediately into water molecules by means of hydroxide ions.

4OH⁻→O₂30 2H₂O+4 e₋

Here, the separated oxygen also rises as colorless gas at the anode. The total reaction equation of the electrolysis of water is:

4H₃O⁺+4OH⁻→2H₂+O₂ +6H₂O

The hydronium and hydroxide ions on the left-hand side originate from the autoprotolysis of the water:

8H₂O→4H₃O⁺+4OH⁻

The electrolysis equation can thus also be expressed as follows:

8H₂O→2H₂+O₂+6H₂O

or, after reducing the water, respectively:

2H₂O→2H₂+O₂

Hydroxide Ion

The hydroxide ion is a negatively charged ion, which is created when bases react with water. Its chemical formula is OH⁻.

A general base B reacts with water according to the following formula:

B+H₂O [symbol] HB⁺+OH⁻

The pH value of the created solution can be determined by means of the concentration of the hydroxide ions. For this purpose, the so-called pH value is first calculated.

pOH=−log c(OH⁻)

And from this, the pH value:

pH=k−pOH

Each temperature has a k in each case.

Under normal conditions, k=−14.

Hydroxide ions are also contained in pure water at 20° C. in a concentration of 10⁻⁷ mol l⁻¹. This is associated with the autoprotolysis of the water according to the following reaction equation:

H₂O+H₂O [symbol] H₃O⁺+OH⁻

Approval

Our own early experiments and test results led to the filing of license applications with the FDA (Food and Drug Administration, USA), which gave approval for the new technology in December of 2002 and marked it with the status “GRAS” (Generally Regarded as Safe).

Electrolyzed oxidative water obtained FDA (USA Food and Drug Administration), USDA (United States Department of Agriculture) and EPA (USA Environmental Protection Agency) approval for general applications in the field of food products, for the food product surface disinfection, for milk, meat and restaurant-related applications. The corresponding pages of the authorization numbers of the FDA and USDA are 21 CFR 173, 178, 182, 184 and 198.

The EPA authorization and publication page is 40 CFR 180.940 and that of the National Organic Programis 21 CFR 178.1010.

In Japan, electrolytic water has been approved as food additive, because it is not toxic.

With the electrolytic water product HYDROSEPT, the inventor owns the rights to a biocide entry at the Federal Office for Public Health in Bern, Switzerland.

In statistically relevant field tests in the apple tree against apple scab, the new systemic crop protection method reached an efficiency of 92.6%.

Other cultures, in which the invention was tested and which were treated preventatively, did not show a yield of reduced damages.

According to the inventor's knowledge, scientific works in the field of systemic crop protection have not yet been published, which, by means of oxidative radicals (electrolytic water) produced electrolytically in water, by adding ion-forming mineral salts, and with the help of electrochemically separated water molecule clusters of only 2 to 3 molecules, which can penetrate from the base of the smaller molecule structure through cell membranes, and with the help of the new injector technology, can ensure an efficient systemic biocidal crop protection.

### THE SOLUTION OF THE TASK

The solution of the task is defined by the features of the independent patent claims.

According to the invention, the method for use in systemic crop protection against harmful fungi, yeasts, bacteria, viruses, spores, protozoans and harmful insects specifies the manner of the biocides, in particular of the specific characteristics of the electrolyzed, oxidative water, the production thereof, the salt concentration and salt composition thereof, the redox potential thereof or the concentration thereof in free oxidative radicals, respectively, and total concentration of the oxidative radicals, and the pH value thereof and spray rate for an efficient systemic injection spray process via pressurized injection ampoules.

According to the invention, the method furthermore specifies the mode of operation of the pressurized injection ampoules or hand-held injectors or of other types of syringes.

The invention forms an integrated system, into which the technical components for the oxidative radical production in the water, the injection technology are integrated into the phloem of plants, bushes and trees with the corresponding injection applicators in the form of pressurized injection ampoules or hand-held injectors or other types of syringes, are integrated.

The focus of the innovation is thereby not only the combination of electrolytically oxidative water (active water) and the pressure injection technology application for the novel systemic pest control in crop protection, but also the combined novel application technology for plant nutrients, mainly in the composition of the suitable nutrient salt combinations and oligoelements, which are approved for the organic production, which do not cause any phytotoxic harm to plants and which, in electrolytic form, furthermore have an optimal effect as biocides against plant pests, such as pathogenic bacteria, viruses, fungi and yeasts.

The inventor determined, tested and optimized these suitable nutrient salt combinations and oxidative radical concentrations in the injection water in laboratory and field tests in an empirical and practical manner for more than 30 different agricultural and horticultural types of plants.

The novel combined application technology, together with the correct nutrient salt combinations and the corresponding concentrations of the oxidative radicals, are essential for the successful use of electrolytic oxidative radicals in the water and fulfill all of the parameters for the optimal mode of action of the novel systemic crop protection method.

The invention is furthermore innovative with regard to the production of the oxidative radicals by means of two methods, the electrolysis in an electrolytic cell comprising full diamond electrodes and the cylinder electrolysis comprising platinum electrodes, which, in response to the electrolysis of mineral nutrients in the water, with Na⁺ and Cl⁻ ions, mainly produce Cl⁻ ions, and not H⁺ ions. This fact provides for the production of organically degradable hypochloride compounds (HOCL) or hypochlorite acid H₂CLO—, which are not toxic from a plant-physiological aspect. In addition, the cylinder electrolysis produces more ozone (O₃), thanks to its special design and the platinum electrodes.

The invention of the novel systemic crop protection method substantially consists in the combination of the electrolytic production of oxidative radicals in water in 2 different possible production methods (biocide), the mixing thereof and temporary storage in the tank and the subsequent extraction of the biocides by means of the different injection applications, injection ampoule, hand-held injector, etc. as biocide injectors leads to a systemic ultra-quick superoxidation of the pathogens.

The novel systemically acting application method in crop protection by means of electrolytically oxidative radicals and by using special designed injectors consists of the following technical components:

1. Pressurized injection ampoules or hand-held injector or other types of syringes.

2. Filling device for filling and refilling injection ampoules and other injection applicators.

3. One or a plurality of electrolytic cell(s) comprising full diamond electrodes, in each case comprising 1 to 3 or a plurality of electrolysis chambers, depending on the need, with volume flow gauge and flow probe and corresponding control device comprising manual and automatic cathode and anode load reversal, installed amperemeter and voltmeter and lamp function control, comprising automatic shut-off without volume flow, including pressure regulating and return flow stop valve, lines and connections and control valve and sample removal location (220 or 340 V).

4. One or a plurality of reservoir water tank(s) for accommodating the electrolytic oxidative radicals in the water in the volume dimensions of the corresponding syringe types, ideally of 1-4000 liters or more.

5. One or a plurality of circulating pumps according to the specific output, which is to be provided per hour, with a minimal pressure capacity of 4 atm, including electronic control with “ON” and “OFF” switch, including oxidation-free lines of Viton, Teflon or PVC or a corresponding other suitable material.

6. Two or a plurality of pressure gauges and pressure control valves with return function.

7. Redox measuring devices for measuring the oxidative radical concentration in the tank.

8. In the alternative, one or a plurality of cylinder electrolytic cell(s) comprising plate electrodes and diaphragm cells—break-up with anode and cathode with reverse function for producing acidic and basic electrolytic water comprising anionic and cationic oxidative radicals, comprising an electric control, current pulsator and protection by means of control device comprising manual and automatic cathode and anode load reversal, installed amperemeter and voltmeter and lamp function control, comprising automatic switch-off without volume flow, including lines and connections and control valve and sample removal location (220 or 340 V), including redox measuring device for the anodic and cathodic electrolyte liquid, including electronic mixer faucet, which serves to adjust the desired pH value of the electrolytic oxidative water (EOW).

9. Power source from socket or battery, from the solar energy supply plant or from power generators, produced individually or via power take-off drive, including controls and safeguards.

The innovative application method of the invention includes 6 essential steps:
1. Producing the biocidal oxidative radicals and breaking up the water molecule clusters into 2 to 3 molecules in an aqueous, mineral salt-containing nutrient solution using electrolysis.
2. Filling, under pressure, electrolyzed plant-physiological nutrient solution and biocidal oxidative radicals with compressed gases, nitrogen, CO2, and/or argon into the injection ampoules, hand-held injectors, etc. in a filling station.
3. Placing the injection cannulae on plants or trees using a drill. Screwing the injection cannulae into the phloem of the plants (sap flow).
4. Grafting on the pressurized injection ampoules.
5. Automatically, slowly and constantly administering the injection to the phloem of the plant.
6. Repeating the application as required.

1. Production of the Biocidal Oxidative Radicals in Aqueous, Mineral Salt-Containing Solution by Means of Electrolysis.

The production of the biocidal oxidative radicals in aqueous, mineral salt-containing solution takes place by means of two electrolysis methods, which are different, yet complement one another.

The first method is implemented with the electrolysis by means of full diamond electrodes. A cocktail consisting of oxidative radicals close to the “neutral range” with a pH value of between 7.6 and 8.2 is created thereby. In addition to the OH hydronium groups and O₃, mainly free chlorine (Cl₋) is formed at the anode, which, together with the hydronium groups, lead to the formation of hypochlorous acid HOCL and H₂OCl ions, which are very quickly broken down organically. So as to be able to carry out the electrolysis of the water more cost-efficiently and better with regard to the power consumption, different nutrient salts and inorganic oligoelements, which are approved for organic farming, are added to the water due to the improved electrode conductivity and for the improved nutrient supply of the plants and trees.

Oxidizing reducing peroxide disulfate, peroxide diphosphate and percarbonate are also created in response to the electrolysis of these nutrient salt compounds.

For example, these nutrient salts are per liter of injection liquid: (for young plants)

1.5 gr. NaCl (sodium chloride) or KCl (potassium chloride)

0.3 gr. K2SO4 (potassium sulfate)

0.3 gr. Na3PO4 (sodium phosphate)

0.1 gr. Mg2SO4 (magnesium sulfate)

After the electrolysis took place, this saline solution must also have a concentration of at least 35 ppm or 35 mg per liter of oxidative radicals as overall total or approx. 17 ppm or 17 mg per liter of free chlorine compounds.

For example, these salts, per liter of injection liquid, are: (for growing plants and for full-grown plants):

2.25 gr. NaCl (sodium chloride) or KCl (potassium chloride)

0.45 gr. K2SO4 (potassium sulfate)

0.45 gr. Na3PO4 (sodium phosphate)

0.2 gr. Mg2SO4 (magnesium sulfate)

Depending on the plant type and growth stage and infection pressure, these concentrations can differ!

After the electrolysis took place, this saline solution must also have a concentration of at least 90 ppm or 90 mg per liter of oxidative radicals as overall total or approx. 45 ppm or 45 mg per liter of free chlorine compounds.

Depending on plant type and purpose, these salt compositions can also be different, both as salts as well as in the concentration thereof.

The second method is implemented with the cylinder electrolysis with diaphragm, where the electrolytic cells are separated from one another, consisting of an anode chamber and a cathode chamber. Acid-forming negatively charged anions in an acidic range of approx. 2.4 pH comprising a negative charge are formed at the positive anode of platinum, base-forming positive cations in an alkaline range of approx. 11 pH with a positive charge are formed at the negative cathode.

These two acidic and alkaline aqueous electrolysis solutions can now be mixed randomly and, depending on the use and infection pressure or pathogen infestation—can be injected into the plants or trees.

In the case of the electrolysis of tap water without salt additives, the following oxidative radicals are formed:

Elecrolytic Process of Water

A variety of oxidative radicals are created, when water (H₂O) is electrolyzed, for example: (E0 is the standard redox potential)*:

| | |
|---|---|
| O₂ + H + e⁻ → HO₂ | E0 = −0.13 V [1] |
| 2H⁺ + 2e⁻ → H₂ | E0 = 0.00 V [2] |
| HO₂ + H⁺ + e⁻ → H₂O₂ | E0 = +1.50 V [3] |
| O₃ + 2H⁺ + 2e⁻ → O₂ + H₂O | E0 = +2.07 V [4] |
| OH⁻ + H⁺ + e⁻ → H2O | E0 = +2.85 V [5] |
| H₂O + e⁻ → H + OH⁻ | E0 = −2.93 V [6] |
| OH + e⁻ → OH⁻ | E0 = +2.02 V [7] |

Elektrolytic Process of Water with Salt NaCL

On the Cathode Side

Na⁺e⁻→Na

2Na+2H₂O→2Na⁺+2OH⁻+H₂

On the Anode Side

2Cl⁻→Cl₂+2 e⁻

It is important to note herein that Cl₂ (chlorine gas) and OH— react as follows:

Cl₂+2OH⁻→ClO⁻+Cl⁻+H₂O

or

Cl₂+OH⁻→HClO+Cl⁻

In the case of this decomposition, a plurality of oxygen-containing, highly-reactive oxidative radicals is created, the most frequently appearing hydroxyl-free radical is HO═ (Hoigné, 1988).

All of these free oxidative radicals have very short half-life periods (nanoseconds) and oxidize organic substances very quickly.

The oxidation potential of molecular ozone, O₃, is 2.07 eV, while that of the free hydroxyl radical, HO═, is 2.83 eV.

Due to the fact that the electrolytic water solution also includes ozone O₃ and H₂O₂, a gene-eliciting triggering of a SAR (Systemic Acquired Resistance) in the plants, a systemic immune protection reaction is simultaneously triggered in the plant.

The catalytic function of ozone and hydrogen superoxide causes the same defensive reactions in the plant or in a tree, as in response to an attack by an insect or a bacterium or virus. In complicated chemical cascade reactions, the plant or the tree forms different antibodies and defense mechanisms against pathogens, such as Phytoalexine, Phenole Therpentene, Kumarine, Isoflavonoide, Grapevine Reservatrol etc. on the basis of 3 known chemical tracks (Salizyl acid, Jasmonic acid and ethylene tracks).

On the one hand, these substances lead to the destruction of the pathogens or act as repellent for insects, etc..

The plant or the tree thus forms systemic substances internally for its protection. In response to every treatment with electrolyzed, active water, the immunizing protection of the plant is thus strengthened from inside. These defense mechanisms are genetically anchored in most plants and are phenotypically indifferent in pest control for the most part, that is, all of the “defense systems” against invaders and enemies are mobilized simultaneously.

These defense mechanisms require a great deal of intrinsic energy from the plant. A good supply with nutrients and water, without further stress factors, are thus conditions for the successful application of the systemic electrolytic water plant therapy for additionally increasing the plant's own systemic immune protection.

### EMBODIMENT OF THE INVENTION

To embody the novel systemic crop protection method for preventing and controlling fungi, bacteria and virus infections in agricultural, horticultural and tree cultures by means of electrolytically produced oxidative radicals, the invention will be explained visually using the example of an injection application on a tree.

Injection Procedure

1. Drilling a small hole into the trunk and inserting the injection cannula at the tree trunk by slightly rotating.

2. Attaching the electrolytic water ampoule to the injection cannula.

3. The pressurized injection ampoule injects electrolytic water with nutrients as bactericide, virucide or fungicide into the phloem of the tree trunk. The biocidal liquid spreads slowly into all parts of the tree.

4. Repetition of the application, as required, until pathogens can no longer be detected in the plant.

1. A method in systemic crop protection for controlling and eliminating pathogenic fungi, yeast, bacteria virus infestation in plants by means of electrolytic water, which, as biocides, contains oxidative radicals, which are electrolytically produced from mineral salt-containing water, wherein the electrolytic water is injected into the phloem of a plant under pressure.

2. The method according to claim 1, characterized in that the water molecule clusters are broken up into two to three molecules in response to the electrolysis.

3. The method according to claim 1, characterized in that the electrolytic water is produced in an electrolysis method comprising diamond electrodes and/or by means of cylinder electrolysis comprising diaphragm and metal electrodes, preferably platinum electrodes.

4. The method according to claim 1, characterized in that the electrolytic water additionally contains plant nutrients in mineral form, furthermore ozone and hydrogen peroxide H₂O₂ biocides, which serve as reaction catalysts for an ultra-quick superoxidation of pathogenic germs in plants, and as SAR (Systemic Acquired Resistance)-triggering stressors.

5. The method according to claim 4, characterized in that the following nutrient salts are used in the following concentrations per liter of injection liquid for young plants in the mineral salt-containing water for electrolytically producing the oxidative radicals:
1.5 g NaCl (sodium chloride) or KCl (potassium chloride), 0.3 g K₂SO₄ (potassium sulfate), 0.3 g Na₃PO₄ (sodium phosphate), 0.5 g MgSO₄ (magnesium sulfate), wherein, after the electrolysis took place, the saline solution has a concentration of at least 35 ppm or 35 mg/l of oxidative radicals as overall total or approx. 17 ppm or 17 mg/l of free chlorine compounds, with a pH of preferably 8.2.

6. The method according to claim 4, characterized in that, for growing plants and for full-grown plants, the following nutrient salts are used in the following concentrations per liter of injection liquid for electrolytically producing the oxidative radicals:
2.25 g NaCl (sodium chloride) or KCl (potassium chloride), 0.45 g K₂SO₄ (potassium sulfate), 0.45 g Na₃PO₄ (sodium phosphate), 0.6 g MgSO₄ (magnesium sulfate),
wherein, after the electrolysis took place, the saline solution has a concentration of at least 90 ppm or 90 mg/l of oxidative radicals as overall total or approx. 45 ppm or 45 mg/l of free radicals, with a pH of preferably 2.4.

7. The method according to claim 1, characterized in that the electrolytic water is filled, under pressure, into injection ampoules, hand-held injectors, etc. by means of compressed gas, nitrogen, CO₂ and/or argon in a filling station.

8. The method according to claim 1, characterized in that a hole is drilled into the plant, an injection cannula is placed into the hole and is screwed into the phloem of the plant (sap flow), the pressurized injection ampoule is grafted on and the injection liquid is injected automatically, slowly and steadily into the plant phloem, wherein the application is repeated, if required.

9. The method according to claim 1, wherein the electrolytic water is injected for treating fire blight (Erwinia Amylovora) in pomiculture.

10. The method according to claim 1, wherein the electrolytic water is injected for treating apple scab (Venturia inaequalis) in pomiculture.

11. A device for carrying out the method according to claim 1, characterized in that it encompasses the following components:
one or a plurality of electrolytic cells comprising full diamond electrodes, in each case comprising one to three or a plurality of electrolysis chambers, depending on the need, with volume flow gauge and flow probe and corresponding control device comprising manual and automatic cathode and anode load reversal, installed amperemeter and voltmeter and lamp function control, comprising automatic shut-off without volume flow, including pressure regulating and return flow stop valve, lines and connections and control valve and sample removal location (220 or 340 V)
pressurized injection ampoules or hand-held injectors or other types of syringes,
a filling device for filling and refilling the injection ampoules, hand-held injectors or other types of syringes,
one or a plurality of reservoir water tanks for accommodating the electrolytic water in the volume dimensions of the corresponding syringe types, in particular of 1 liter to 4000 liters or more,
one or a plurality of circulating pumps according to the specific output, which is to be provided per hour, with a minimum pressure capacity of 4 Atm including electronic control with “on” and “off” switch, including oxidation-free lines of Viton, Teflon or PVC or a corresponding other suitable material,
two or a plurality of pressure gauges and pressure control valves with return function, redox measuring devices for measuring the oxidative radical concentration in the tank,
power source from socket or battery, from a solar energy supply plant or from a power generator, produced individually or via power take-off drive, including controls and safeguards.

12. A device for carrying out the method according to claim 1, comprising:
one or a plurality of cylinder electrolytic cells comprising plate electrodes and diaphragm cells—break-up with anode and cathode with reverse function for producing acidic and basic electrolytic water comprising anionic and cationic oxidative radicals, comprising an electric control, current pulsator and protection by means of control device comprising manual and automatic cathode and anode load reversal, installed amperemeter and voltmeter and lamp function control, comprising automatic switch-off without volume flow, including lines and connections and control valve and sample removal location (220 or 340 V), including redox measuring device for the anodic and cathodic electrolyte liquid, including electronic mixer faucet, which serves to adjust the desired pH value of the electrolytic oxidative water,
pressurized injection ampoules or hand-held injectors or other types of syringes,
a filling device for filling and refilling the injection ampoules, hand-held injectors or other types of syringes,
one or a plurality of reservoir water tanks for accommodating the electrolytic water in the volume dimensions of the corresponding syringe types, in particular of 1 liter to 4000 liters or more,
one or a plurality of circulating pumps according to the specific output, which is to be provided per hour, with a minimum pressure capacity of 4 Atm including electronic control with “on” and “off” switch, including oxidation-free lines of Viton, Teflon or PVC or a corresponding other suitable material,
two or a plurality of pressure gauges and pressure control valves with return function,
redox measuring devices for measuring the oxidative radical concentration in the tank,
power source from socket or battery, from a solar energy supply plant or from a power generator, produced individually or via power take-off drive, including controls and safeguards.
